(19) United States
(12) Patent Application Publication
(10) Pub. No.: US 2007/0219420 A1
(43) Pub. Date: Sep. 20, 2007

(54) Subscription-Based Catastrophe-Triggered Rescue Services Facilitation Method Using Wireless Location Information

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/462,845

(22) Filed: Aug. 7, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.

(51) Int. Cl. A61B 5/00

(52) U.S. Cl. 600/300

(57) ABSTRACT

Pre-catastrophe consideration-based private civil security subscriptions are accepted (101) from subscribers with respect to providing civilly-catastrophic event-based rescue services for authorized beneficiaries. These authorized beneficiaries are then provided (102) with a portable apparatus that transmits wireless location information regarding their corresponding location to a provider of the civilly-catastrophic event-based rescue services. These teachings then provide for using (106) this received (105) wireless location information to facilitate maintaining a substantially immediate capability of rescuing the authorized beneficiaries in response to a civilly-catastrophic event.

### RELATED APPLICATIONS

This comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043; and

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624; and

SUBSCRIPTION-BASED INTERMEDIATE SHORT-TERM EMERGENCY SHELTER METHOD as filed on Aug. 7, 2006 and having application Ser. No. 11/462,795, the contents of which are fully incorporated herein by this reference.

### TECHNICAL FIELD

This invention relates generally to facilitating rescue services.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as water, nutrition, shelter, and the like as well as numerous miscellaneous luxuries.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

When a civilly-catastrophic event occurs, substantially sudden civil upheaval will often follow. Such upheaval, which can occur even without the advent of an uncooperative and/or panicked populace, can in turn lead to considerable survival-related problems for persons within the affected location. In many cases it may be useful or even critical to at least temporarily evacuate the troubled location. Therein, however, lies something of a conundrum. On the one hand, modem governments typically do little to proactively ensure the ability to quickly and safely effect transport of their citizens in the face of most civilly-catastrophic events. On the other hand, attempting to take responsible actions to reasonably ensure one's own abilities in this regard can become, in and of itself, a seemingly insurmountable challenge. For example, even when survival facilities (such as, for example, an emergency shelter) are available, a given individual may lack the means, expertise, skills, or ability to safely reach that facility during a time of need.

### BRIEF DESCRIPTION OF THE DRAWINGS

The above needs are at least partially met through provision of the subscription-based catastrophe-triggered rescue services facilitation method using wireless location information described in the following detailed description, particularly when studied in conjunction with the drawings, wherein:

FIG. 1 comprises a flow diagram as configured in accordance with various embodiments of the invention;

FIG. 2 comprises a perspective schematic view as configured in accordance with various embodiments of the invention;

FIG. 3 comprises a block diagram view as configured in accordance with various embodiments of the invention;

FIG. 4 comprises a flow diagram as configured in accordance with various embodiments of the invention;

FIG. 5 comprises a block diagram as configured in accordance with various embodiments of the invention;

FIG. 6 comprises a block diagram as configured in accordance with various embodiments of the invention; and

FIG. 7 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, pre-catastrophe consideration-based private civil security subscriptions are accepted from subscribers with respect to providing civilly-catastrophic event-based rescue services for authorized beneficiaries. These authorized beneficiaries are then provided with a portable apparatus that transmits wireless location information regarding their corresponding location to a provider of the civilly-catastrophic event-based rescue services. These teachings then provide for using this received wireless location information to facilitate maintaining a substantially immediate capability of rescuing the authorized beneficiaries in response to a civilly-catastrophic event.

The aforementioned portable apparatus can assume any of a wide variety of form factors and associated functionality. These teachings will also readily accommodate providing a given authorized beneficiary with a plurality of such apparatuses to facilitate ready proximity and availability of the portable apparatus for the purposes described herein. The wireless location information can serve to guide rescuers to a present location of the corresponding authorized beneficiary during a time of need. This information can also serve to inform the pre-catastrophe allocation of rescue resources such as transport, personnel, and so forth.

So configured, a present rescue capability for affected individuals is greatly improved. The authorized beneficiary will have a considerably improved likelihood of being located during a time of need to effectuate such a rescue. In addition, by permitting a provider of such rescue services to have pre-catastrophe information regarding the location of such authorized beneficiaries, the provider can make corresponding dynamic allocations, de-allocations, and re-allocations of rescue resources to improve a present capability of effecting a substantially immediate rescue of such authorized beneficiaries. Such information can also serve to aid in avoiding a misallocation of rescue resources in a manner that is cost ineffective and that would otherwise needlessly increase the ongoing costs of providing such a rescue service capability.

These steps can be facilitated without dependency upon governmental oversight, participation, or control. The particular rescue services provided can vary with the needs and requirements of the authorized beneficiaries. Importantly, via these teachings an individual can take important steps to bring a considerably improved measure of security into their lives, knowing that, should a civilly-catastrophic event indeed be visited upon them, they will be rescued and moved, safely and effectively, from a location of (and possibly through) civil upheaval.

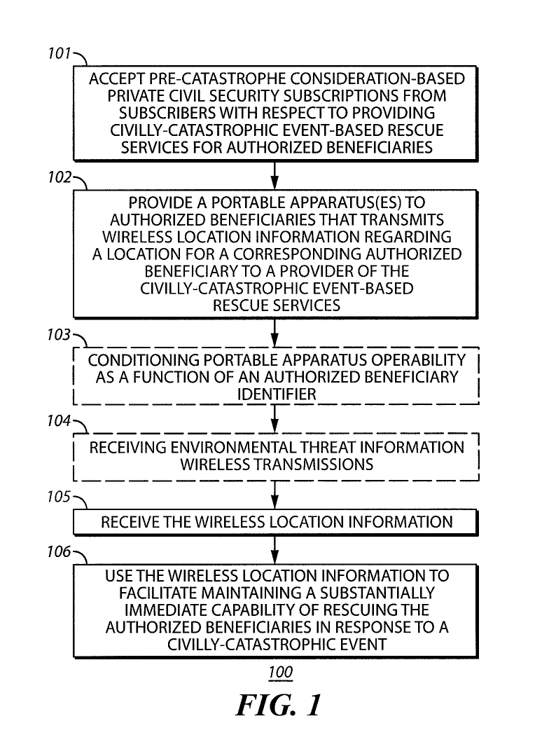

These and other benefits may become clearer upon making a thorough review and study of the following detailed description. Referring now to FIG. 1, a corresponding illustrative process 100 provides for accepting 101 pre-catastrophe consideration-based private civil security subscriptions from subscribers with respect to providing civilly-catastrophic event-based rescue services for authorized beneficiaries. This right of rescue can pertain, if desired, to a predetermined timeframe. For example, a given subscription can relate to providing rescue services as may be required during a given one year period for one or more authorized beneficiaries as are covered by a given subscription. The precise nature of the rescue services themselves can vary greatly to reflect the needs and/or opportunities as characterize a given application setting. Numerous relevant illustrative examples may be found in the aforementioned patent application entitled SUBSCRIPTION-BASED CATASTROPHE-TRIGGERED RESCUE SERVICES FACILITATION METHOD AND APPARATUS.

By one approach, these subscriptions may be accepted by, for example, a for-profit business. By another approach a not-for-profit business (such as a membership-based entity) may be the appropriate entity to offer and accept such subscriptions. If desired, such subscriptions may also provide access to one or more life-sustaining resources (such as one or more selections from one or more of life's necessities such as hydration, nourishment, shelter, environmentally-borne threat abatement, and/or transportation away from a location of substantial civil upheaval to a secure location). Illustrative examples in this regard may be found in many of the aforementioned patent applications including but not limited to the patent application entitled SUBSCRIPTION-BASED PRIVATE CIVIL SECURITY FACILITATION METHOD.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of rescue (as where a subscription provides rescue rights for a specific period of time, such as one year, in exchange for a corresponding series of payments);

event-limited rights of rescue (as where a subscription provides rescue rights during the life of a given subscriber based upon an up-front payment in full and where those rescue rights terminate upon the death of the subscriber or where, for example, a company purchases a subscription for a key employee and those corresponding rights of rescue terminate when and if that key employee leaves the employment of that company);

inheritable rights of rescue (as may occur when the subscription, by its own terms and conditions, provides a right of rescue that extends past the death of a named subscription beneficiary and further allows for testate and/or intestate transfer to an heir);

rights of rescue predicated upon a series of periodic payments (as where a subscription provides rescue rights during, for example, predetermined periods of time on a periodic basis as where a subscriber offers month-by-month payments to gain corresponding month-by-month rescue rights);

rights of rescue predicated upon a one-time payment (as may occur when a subscriber makes a single payment to obtain a time-based or event-based duration of rescue rights or, if desired, when a single payment serves to acquire a perpetual right of rescue that may be retained, transferred, inherited, or the like);

ownership-based rights of rescue (as may occur when the subscription provides for ownership rights regarding rescue);

non-transferable rights of rescue (as may occur when the subscription, by its terms and conditions, prohibits transfer of the right of rescue from a first named beneficiary to another);

transferable rights of rescue (as may occur when the subscription, by its terms and conditions, permits conditional or unconditional transfer of the right of rescue from a first named beneficiary to another);

membership-based rights of rescue (as may occur when the subscription, by its terms and conditions, establishes a membership interest with respect to the accorded right of rescue such as, for example, a club-based membership);

fractionally-based rights of rescue (as may occur when the subscription, by its terms and conditions, establishes a divided or undivided co-ownership interest by and between multiple subscription beneficiaries with respect to a right of rescue); and/or

non-ownership-based rights of rescue (as may occur when the subscription, by its terms and conditions, establishes the aforementioned right of rescue via, for example, a lease, rental, or borrowing construct).

By one approach the aforementioned rescue services may be provided without geographic limitations; that is, an attempt will be made to effect the rescue of a corresponding authorized beneficiary regardless of where that authorized beneficiary might happen to be upon the occurrence of a triggering civilly-catastrophic event. By another approach, such rescue services may only be available on a geographically limited basis. For example, these rescue services may only be available to a given authorized beneficiary when that beneficiary is located within specific geographic areas. Exemplary areas might include, for example, major urban areas, specific countries, and so forth.

If desired, a plurality of differentiated subscription opportunities can be offered in this regard. This plurality of differentiated subscription opportunities can correspond, for example, to providing access to differing transport modalities, transport accommodations, predetermined locations, guaranteed and/or target response times, levels or degrees of rescue service effort and/or time that will be administered to effect a rescue, categories and/or kinds of rescue equipment and/or personnel, and so forth. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing rescue services that are economically selected while another subscription might provide for rescue services that are more costly and in turn reflect, for example, a wider variety of choices with respect to rescue modality, minimum levels of guaranteed effort, accommodations, creature comforts, and so forth.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing privately-effect rescue in the event of a civilly-catastrophic event. Such services may be predicated, if desired, upon a requirement that the civilly-catastrophic event be one that causes at least a predetermined amount or degree of civil infrastructure impairment or other measurable impact of choice.

As used herein, “civilly-catastrophic event” will be understood to refer to an event that substantially and materially disrupts a society's local, regional, and/or national infrastructure and ability to provide in ordinary course for the survival needs of an impacted community. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail, rain, and the like, flooding, and so forth), extreme geological events (such as earthquakes, volcanic activity, and so forth), severe astronomical-based events (such as extreme solar flares, collisions with comets or large asteroids, and so forth), extreme environmental events (such as widespread uncontrolled fire or the like), severe disease-based events such as global or regional pandemics, a severe natural shortage of a life-sustaining resource, and so forth, to note but a few.

Examples of non-naturally-caused disasters capable of initiating a civilly-catastrophic event include both unintended events as well as acts of war, terrorism, madness or the like. Examples of non-naturally-caused disasters capable of such potential scale include, but are not limited to, nuclear-related events (including uncontrolled fission or fusion releases, radiation exposure, and so forth), acts of war, terrorism, and related aggression, the accidental or intentional release and public dispersal of a severe environmentally borne danger such as deadly or otherwise disruptive biological or chemical agents or creations, and so forth.

As one option, if desired, this process 100 can further accommodate accepting what amounts to a secondary subscription for secondary rescue rights. By this approach, less expensive subscriptions can be provided for rescue if and when a first tier of primary authorized beneficiaries are successfully rescued. By one approach, if desired, the primary subscribers could share in the consideration offered by such secondary subscribers.

By one approach, such a subscription can provide for the rescue of both a specifically identified authorized beneficiary as well as at least one presently unnamed rescuee. By one approach the identified authorized beneficiary is empowered to identify this additional rescuee at a time of being rescued. This unnamed rescuee might be limited, for example, to comprising only a living being (such as another person, a pet, a working animal, and so forth) or an inanimate object (such as business materials, personal items, a work of art, and so forth), or may be less restricted in this regard as desired.

This process 100 then provides 102 a portable apparatus to these authorized beneficiaries that transmits wireless location information regarding a location for a corresponding authorized beneficiary to a provider of the aforementioned civilly-catastrophic event-based rescue services (either directly to the provider or via an intermediary entity or service). If desired, this portable apparatus can also transmit (integral with the location information or separately there from) other information. Examples in this regard might include an identifier as corresponds to the authorized beneficiary, an identifier as corresponds to the portable apparatus, a time at which a next transmission will occur, encryption information, synchronization information, a timestamp as corresponds to the location information itself, acknowledgement and/or handshake messages and signals, power control and/or signal quality information, and so forth.

This location information can vary with the needs and/or opportunities as characterize a given application setting. By one approach this information can at least comprise information that identifies, to a greater or lesser degree, a particular two-dimensional location of the authorized beneficiary (such as latitude/longitude coordinates, an address, and so forth). If desired, this information can also comprise vertical location information (such as altitude metrics, a floor number for a multi-story building, and so forth).

By one approach this portable apparatus comprises a one-way only platform that serves only to transmit such information. By another approach, this portable apparatus comprises a two-way platform that is configured and arranged to also permit, for example, outbound transmissions to an authorized representative of the rescue service provider. Less restrictive configurations are also possible.

By one approach this portable apparatus is configured and arranged to effect such wireless transmissions in an autonomous automated manner. This can comprise either a scheduled or a non-synchronous approach. If desired, this portable apparatus can also be configured and arranged to effect such wireless transmissions in response to receiving a remote control signal from, for example, the provider of the aforementioned rescue services. By yet another approach, this portable apparatus can be configured and arranged to effect such wireless transmissions in response to a user of the portable apparatus causing such a transmission (for example, by pushing a corresponding button, enunciating a corresponding verbal command, and so forth).

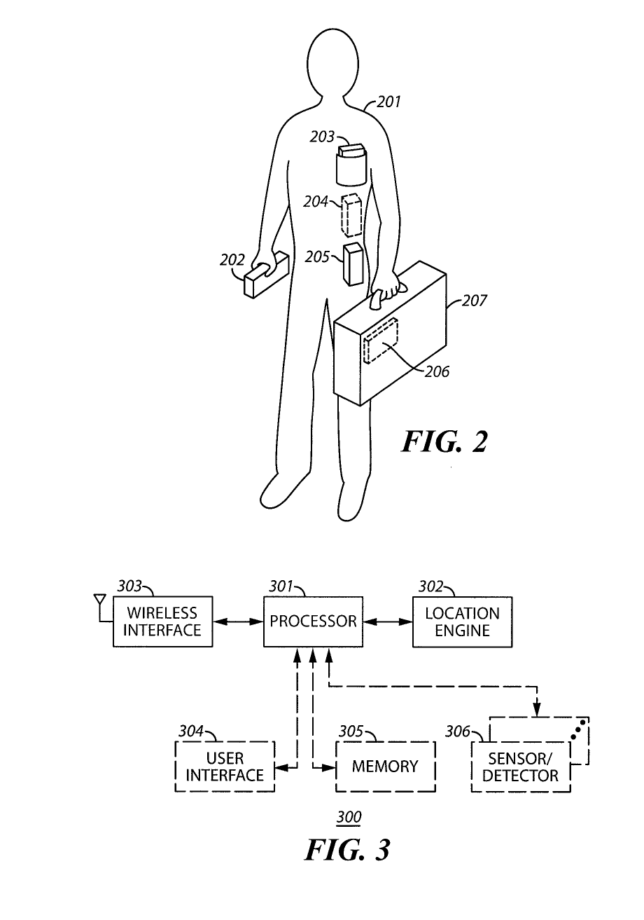

As noted, this apparatus comprises a portable object. With momentary reference to FIG. 2, by one approach this portable apparatus is readily carriable by an average human 201. Accommodations can be offered for smaller, weaker, or otherwise less-than-average sized or able-bodied individuals if desired.

By one approach this can comprise a hand graspable and carriable portable apparatus 202. By one approach, this can also comprise a portable apparatus 204 that has a pocketable form factor and/or a portable apparatus 204 that can be placed within an inner pocket or compartment of the individual's clothing. As yet another example in this regard the portable apparatus 205 can be configured and arranged to clip, for example, to the individual's belt or other available and suitable surface. By another approach the portable apparatus 206 may be totable (within, for example, another container such as a briefcase 207, pursue, backpack, waist/fanny pack, diaper bag, and so forth). In general, those skilled in the art will recognize and understand that such a portable apparatus can also be “carried” by sewing, molding, gluing, taping, bolting, clipping, or otherwise attaching (permanently or temporarily) the apparatus on or in the individual's apparel (including their clothing, footwear, and so forth).

Referring now momentarily to FIG. 3, an illustrative example of a portable apparatus 300 will be provided. Those skilled in the art will recognize and understand that the specifics of this example are only illustrative in nature and are not being presented by way of limitation or as an exhaustive example of all possibilities in this regard.
In this illustrative example, the portable apparatus 300 comprises a processor 301 that operably couples to a location engine 302 and a wireless interface 303 of choice. The processor 301 can comprise a partially or fully programmable platform, for example, that is configured and arranged to operate as described herein. The platform itself can serve other purposes as desired. For example, this platform can comprise a part of a cellular telephone, a personal digital assistant, an email platform, a shortwave receiver, a text messaging platform, a two-way pager, a satellite phone, a stored audio playback platform, a hand-held game, a commercial broadcast receiver, a key fob, spectacles, a wallet, a pocket folio, a belt, a hair barrette, a hair band, jewelry, a timepiece, a writing instrument, or a binder, to note but a few possibilities in this regard.

There are many location engines that are presently known in the art and others will no doubt be developed going forward. Any one or more of these approaches may serve well in a given application setting. By one approach, the location engine 302 can comprise, at least in part, a global positioning satellite system (GPS)-based platform that utilizes, when available, satellite-based wireless emissions to determine a relative location in three dimensions. By another approach, either in combination with the GPS approach or in lieu thereof, the location engine 302 can comprise a dead reckoning platform, a so-called signpost-based platform (where the location engine receives nearby location beacon broadcasts to ascertain a present relative position), and so forth.

Similarly, there are various known wireless interfaces (including both one way and two way wireless interfaces) that may be readily applied in conjunction with these teachings. It would also be expected that these teachings will be readily compatible with future developments in this regard as well. By one approach this wireless interface 303 may comprise a relatively short range interface (such as, for example, a Bluetooth-based interface). By another approach, this wireless interface 303 may comprise a relatively longer range interface. It would also be possible to provide a plurality of wireless interfaces having different capabilities and operating characteristics to aid with increasing a likelihood that the portable apparatus 300 will be able to successfully effect its intended communications under a variety of operating conditions.

If desired, this portable apparatus 300 can further comprise a user interface 304. This user interface 304 can provide a way to present information to a user of the portable apparatus 300. This can be accomplished by a variety of audible, visual, and/or haptically-based mechanisms including, but not limited to, audio sources and/or transducers of various kinds, signal lights, alphanumeric and/or pixilated displays of various kinds, vibration imparting mechanisms, and so forth. This user interface 304 can also comprise, either in combination with the output capability just described or in lieu thereof, a way to permit a user of the portable apparatus 300 to provide input to the portable apparatus 300. Again, this can be accomplished using any of a wide variety of mechanisms in this regard including audio-based inputs (including speech recognition capabilities), touch-based inputs (including switches, buttons, cursor controls, touch screens, and so forth), and visually-based inputs, to note a few.

This portable apparatus 300 can also optionally comprise, if desired, a memory 305 that operably couples to the processor 301. By one approach, this memory 305 can serve, at least in part, to store information regarding one or more survival behaviors. By one approach, such information can be broadcast in response to anticipating or detecting a given civilly-catastrophic event and can comprise information specific to responding to that event. This can comprise any of a wide variety of informational content items including information of interest to a relatively wide audience, information intended for only the authorized beneficiaries of the above-mentioned subscriptions, and/or information intended in particular for a specific authorized beneficiary. By one approach this information can comprise audio content, visual content, or audio-visual content as desired.

By another approach, either in combination with the above approach or in lieu thereof, this stored information can be pre-provisioned in the memory 305 prior to an actual present need for such information. Again, the informational content itself can vary widely to meet the specific needs and/or opportunities of a given application setting. By one approach, this informational content can comprise, in whole or in part, a set of contingency instructions that address a variety of different catastrophic scenarios. Examples in this regard can be found in the aforementioned patent application entitled DOCUMENT-BASED CIVILLY-CATASTROPHIC EVENT PERSONAL ACTION GUIDE FACILITATION METHOD. In such a case, if desired, the portable apparatus 300 can be configured and arranged to receive a wireless transmission that identifies a specific behavior or course of action as is contained in this pre-stored information and to cause that identified content to be presented to the corresponding user of the portable apparatus 300 in response, for example, to a particular civilly-catastrophic event having occurred.

It would also be possible to optionally configure the portable apparatus 300 to have one or more environmental sensors/detectors 306. By one approach, these sensors/detectors 306 can comprise one or more environmental threat detectors that monitor local environmental conditions for one or more proximal environmentally borne hazards. These might include proximal radiation hazards, biological agents, chemical agents, and so forth. Such sensors/detectors 306 can be operably coupled to the processor 301, for example, to permit the latter to use the user interface 304 to warn the user of such a threat and/or to provide specific advice regarding next steps that should preferably be taken to avoid such a threat. By another approach, if desired, the processor 301 could use the wireless interface 303 to transmit information regarding a sensed/detected threat to another party. For example, this information could be transmitted to the provider of the aforementioned rescue services. Such information could be used, for example, to facilitate detecting and/or confirming the existence of a given civilly-catastrophic event and/or to trigger a rescue event.

By another approach, such a sensor/detector 306 could sense local barometric pressure. This information might then be usable to facilitate the location process. For example, a given barometric pressure reading may be used in an urban setting to aid in identifying the particular floor of a tall building where the portable apparatus is presently located. By yet another approach, such a sensor/detector 306 could be configured and arranged to detect the proximity of another of the portable apparatuses. This can be facilitated, for example, by configuring each such portable apparatus to itself transmit a relatively short range beacon signal. Such a capability could serve, for example, to facilitate authorized beneficiaries locating one another prior to being rescued. To serve such an end, the processor 301 could be programmed to use the user interface 304 to provide a user-discernable indication of such proximity in response to detecting such proximity. This indication could, if desired, provide an indication of relative strength and/or directionality to further aid in locating the proximal portable apparatus.

By yet another approach in this regard, such a sensor/detector 306 could be configured and arranged to detect proximity of a beacon that comprises a guide to a facility that corresponds to a provider of the civilly-catastrophic event-based rescue services. Such a beacon could comprise, for example, a wireless signal of choice. Such beacons are known in the art and other technologies in this regard are likely to be developed in the future to facilitate such a capability. The facility itself could comprise a transportation rally point, a rescue transport pickup point, a short-term shelter, and long-term shelter, and so forth (with considerable details regarding such facilities being available in the aforementioned patent applications).

At least some civilly-catastrophic events may be accompanied by an electromagnetic pulse. Such a pulse can permanently damage many electrical circuits including, for example, the electronic components of such a portable apparatus. With this in mind, it may be desirable to harden at least the critical vulnerable systems of such an apparatus to thereby substantially protect those systems against an electromagnetic pulse. Various ways and means of achieving such a result are known in the art and may be practiced here as desired.

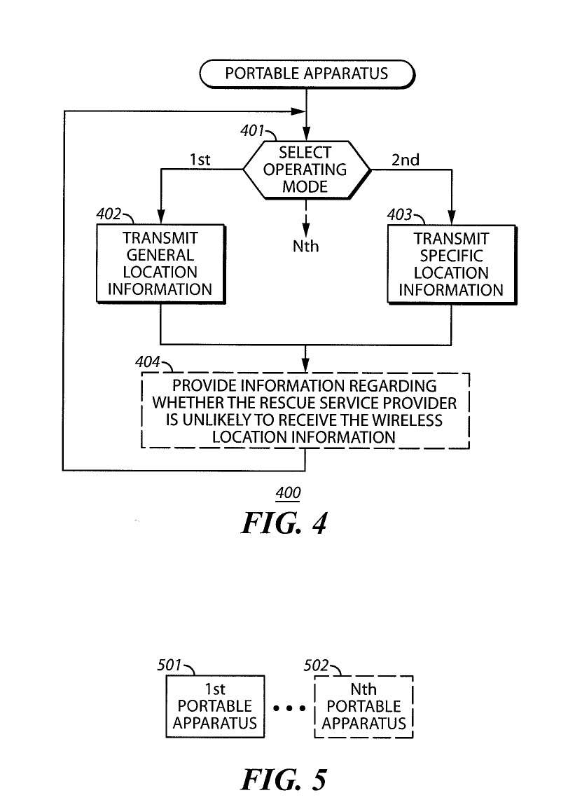

As noted above, this portable apparatus serves to wirelessly transmit location information as corresponds to the present (or at least near term) location of the portable apparatus. The specific nature of this information can vary, if desired. For example, if desired, the portable apparatus can be configured and arranged to have two or more operating modes that each provide for transmission of a different kind of location information. As one example in this regard, and referring momentarily to FIG. 4, an illustrative process 400 can provide for selecting 401 a particular operating mode from a plurality of available candidate operating modes (represented here by a first operating mode through an Nth operating mode, where “N” will be understood to refer to an integer greater than one).

This selection 401 can be automatic in nature and/or can be responsive to a signal from a user of the portable apparatus or from an outside entity such as the provider of the aforementioned rescue services. For example, when responsive to the user, this process 400 may provide for operating in a first mode of operation until the user intentionally initiates the second mode of operation. As another example, when responsive to an external entity, this process 400 can provide for operating in the first mode of operation until reception of a wireless signal that initiates the second mode of operation. Other possibilities along these lines of course exist with the above examples serving only as non-exhaustive illustrations in this regard.

When operating in the first mode of operation, this process 400 can provide for transmitting 402 general location information. Such information might relate, for example, to geographically general information and/or less temporally contemporaneous information. Such information, when received by a provider of the rescue services, could be used to provide notice that a given authorized beneficiary is now in a given area of service and could be used to facilitate rescue resources allocations. By one approach, use of such an operating mode can serve to reduce power consumption requirements for the portable apparatus. This, in turn, can serve to extend the operating life of the portable apparatus during use. Generating and providing only general location information can also serve to address privacy requirements that a given authorized beneficiary may desire.

When operating in the second mode of operation, this process 400 can provide for transmitting 403 specific location information. Such information might comprise, for example, the most current and the highest resolution location information that is available to the portable apparatus. In any event, this specific location information is typically going to be more specific than the general location information and may better serve during a time of specific need (as when the provider of rescue services now seeks to specifically locate the authorized beneficiary in order to effect a rescue of that beneficiary).

By one approach, the portable apparatus can also be configured and arranged to provide 404 information to the user of the portable apparatus regarding when a provider of the rescue services is unlikely to receive the wireless location information. Such information can be based upon a variety of monitored indicia with a specific implementation depending upon the needs and opportunities inherent to a given application setting. When communications between the portable apparatus and the provider of rescue services is characterized by an ever-present or periodically-present pilot signal, for example, an absence of that pilot signal can serve to trigger the aforementioned provision 404 of information.

Such information can, in turn, be used by the user of the portable apparatus to calibrate their own expectations regarding imminent rescue and/or to prompt other useful behaviors. For example, the user can be trained to move to another location where such location information transmissions are more likely to be effective under such circumstances. (Those skilled in the art will recognize and understand that this latter capability can be provided with or without the aforementioned multi-operating mode capability of the portable apparatus.)

The aforementioned step of providing such a portable apparatus to such an authorized beneficiary can further comprise, if desired, providing a plurality of such portable apparatuses to a given authorized beneficiary. With momentary reference now to FIG. 5, this can comprise, for example, providing a first portable apparatus 501 through an Nth portable apparatus 502 to such an authorized beneficiary. By this approach, the authorized beneficiary can distribute the portable apparatuses in various places to thereby improve the likelihood that one of these platforms will be readily available at a time of need.

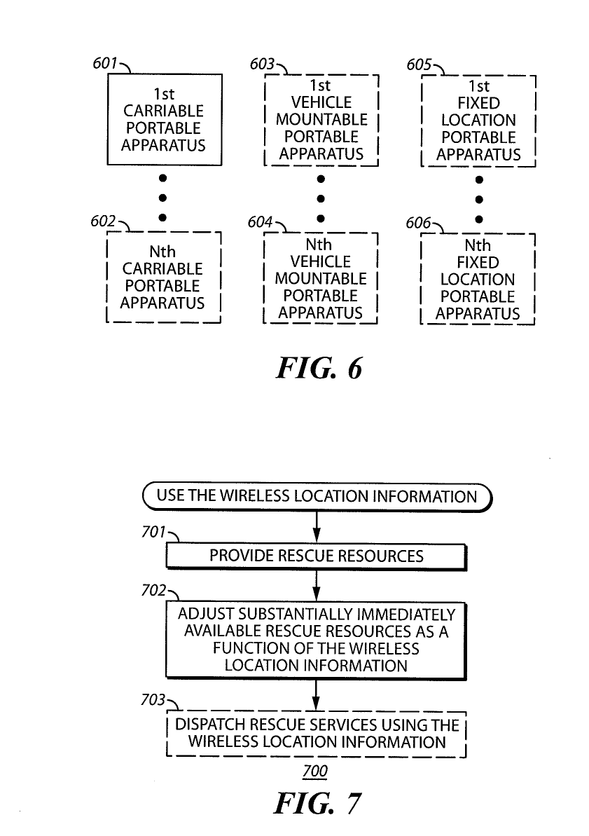

It is also possible that such a plurality of portable apparatuses as provided to a given authorized beneficiary vary from one another in various ways. As one illustrative example in this regard, and referring momentarily now to FIG. 6, a given authorized beneficiary can be provided with a first carriable portable apparatus 601 through an Nth carriable portable apparatus 602 as well as a first vehicle mounted portable apparatus 603 through an Nth vehicle mounted portable apparatus 604. By this approach, the authorized beneficiary can install or at least place the vehicle mounted portable apparatuses in his or her vehicles to thereby render them always available in those vehicles. This would also permit the vehicle mounted platforms to potentially have access to the vehicle's electrical system and/or other location determination engines and capabilities. These assets could then be accessed and used by the vehicle mounted portable apparatuses for the purposes set forth herein.

The illustrative example provided also shows the authorized beneficiary as receiving a first fixed location portable apparatus 605 through an Nth fixed location portable apparatus 606. These latter platforms may be configured and arranged to optionally operate on alternating current as may be available in a given home, office, or the like. Such platforms could also be configured to access other potentially available assets such as an Internet link and so forth. It would also be possible for such portable apparatuses to interact with one another in useful ways if desired.

For example, by one approach, a given one of the portable apparatuses, such as one of the vehicle mounted of fixed location portable apparatuses, could serve as a primary wireless transmitter. So configured, a carriable portable apparatus could then serve as a secondary wireless transmitter. By this arrangement, the carriable portable apparatus could transmit wireless location information to the primary wireless transmitter which then repeats that transmission (possibly using, for example, higher power) to relay that location information to the provider of rescue services.

As another example in this regard, the fixed location portable apparatuses could have known locations. This information, in turn, could be leveraged with respect to ascertaining a present location of a carriable portable apparatus. To illustrate, a given authorized beneficiary could install one of the fixed location portable apparatuses in his or her office on the 45^{th} floor of a tall building. The carriable portable apparatus carried by that authorized beneficiary could interact with that fixed location platform to supplement its own location information with the additional location information regarding the 45^{th} floor that is known to the fixed location platform.

Returning again to FIG. 1, this process 100 can optionally, if desired, condition 103, at least in part, operability of the portable apparatus as a function of an identifier as corresponds to a given one of the authorized beneficiaries. This identifier can comprise, for example, specific information (such as identifying information regarding the individual, a password, and/or a personal identification number) that the authorized beneficiary enters into the portable apparatus. This identifier can also comprise, in lieu thereof or in combination therewith, one or more biometrics as correspond to the authorized beneficiary. Various approaches in this regard exist today and others will no doubt be developed in the future. Examples include but are certainly not limited to fingerprints (or other characterizing asperities), keypad interaction dynamics, vocal characteristics recognition, and so forth.

This process 100 will also accommodate optionally receiving 104 environmental threat information as may be sourced by the portable apparatuses as per the above description or as may be sourced from other resources. This process 100 then provides for receiving 105 the wireless location information as described above and using 106 that wireless location information to facilitate maintaining a substantially immediate capability of rescuing the authorized beneficiaries in response to a civilly-catastrophic event. By one approach, this can comprise using substantially current location information to facilitate locating a given authorized beneficiary and directing rescue resources to that location to effect a corresponding rescue.

Such location information can also serve in a pre-catastrophe setting to inform the allocation of rescue resources such as equipment, transport, personnel, and so forth. To illustrate such an approach, and referring now to FIG. 7, a corresponding process 700 can provide 701 rescue resources (such as, but not limited to, substantially immediately available rescue resources) and then adjust 702 such resources as a function of the received wireless location information. This can generally comprise one or more of bringing on-line additional resources to meet increased near term potential demand, taking off-line some available resources when those resources are no longer necessary to have sufficient rescue capabilities available, and/or reassigning how available on-line resources are presently tasked.

As an illustrative example in this regard, a given dense urban area may presently have 6 authorized beneficiaries located at various locations within that urban setting. To meet this need, three helicopters and their corresponding crews are maintained in a constant state of readiness (and hence comprise a substantially immediate capability of rescuing the authorized beneficiaries). In this particular example, each of the helicopters/crews is initially assigned to two authorized beneficiaries each (it being understood that such assignments might be revised during the course of an actual rescue operation).

In this example, however, incoming location information now reveals that a 7^{th} authorized beneficiary is present in this urban area. When this 7^{th} individual happens to be located proximal to one of the other monitored authorized beneficiaries, one of the existing three helicopter/crew resources may be additionally assigned to this 7^{th} individual. When this 7^{th} individual happens to be located sufficiently distal to any of these existing authorized beneficiaries as to make their present rescue with existing allocated resources unlikely within an acceptable window of performance, this location information can serve instead to inform a decision to bring additional resources (such as a 4^{th} helicopter and crew) into a ready state.

In a similar manner, when one or more of the monitored authorized beneficiaries in this example leave the urban area in question, their location information can be used to inform a decision to reassign and/or to stand down previously allocated rescue assets.

It will be appreciated that these teachings provide for a highly flexible yet powerfully effective way by which a modem citizen can greatly improve their likelihood of receiving rescue services following a civilly-catastrophic event. These teachings are sufficiently flexible so as to accommodate the needs and desires of a wide-ranging set of potential beneficiaries. These teachings will also permit a provider of such services to more effectively and dynamically effect the pre-catastrophe allocation of corresponding rescue resources. This can result in both significant cost savings as well as improved response times and overall effectiveness.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method comprising:
accepting pre-catastrophe consideration-based private civil security subscriptions from subscribers with respect to providing civilly-catastrophic event-based rescue services for authorized beneficiaries;
providing to the authorized beneficiaries a portable apparatus that transmits wireless location information regarding a location for a corresponding authorized beneficiary to a provider of the civilly-catastrophic event-based rescue services;
receiving the wireless location information;
using the wireless location information to facilitate maintaining a substantially immediate capability of rescuing the authorized beneficiaries in response to a civilly-catastrophic event.

2. The method of claim 1 wherein accepting pre-catastrophe consideration-based private civil security subscriptions from subscribers comprises accepting the pre-catastrophe consideration-based private civil security subscriptions at a for-profit business.

3. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access.

4. The method of claim 1 wherein accepting pre-catastrophe consideration-based private civil security subscriptions from subscribers comprises accepting pre-catastrophe consideration-based private civil security subscriptions from subscribers with respect to providing civilly-catastrophic event-based access to a plurality of life-sustaining resources in addition to the rescue services.

5. The method of claim 4 wherein accepting pre-catastrophe consideration-based private civil security subscriptions from subscribers with respect to providing civilly-catastrophic event-based access to a plurality of life-sustaining resources comprises accepting pre-catastrophe consideration-based private civil security subscriptions from subscribers with respect to providing civilly-catastrophic event-based access to a plurality of life-sustaining resources as pertain to a plurality of differing categories of life's necessities.

6. The method of claim 5 wherein the plurality of differing categories of life's necessities comprise at least one of:
hydration;
nourishment;
shelter;
environmentally-borne threat abatement;
transportation away from a location of substantial civil upheaval and to a secure location.

7. The method of claim 1 wherein the civilly-catastrophic event comprises an event that substantially disrupts society's infrastructure and ability to provide at least one life-sustaining resource.

8. The method of claim 7 wherein the civilly-catastrophic event comprises at least one of:
a natural disaster;
an unnaturally-caused disaster.

9. The method of claim 8 wherein the natural disaster comprises at least one of:
a severe weather event;
a severe geophysical event;
a severe astronomical event;
a severe disease-based event;
a severe natural shortage of a life-sustaining resource.

10. The method of claim 8 wherein the unnaturally-caused disaster comprises at least one of:
warfare;
an act of terrorism;
an accident that results in public dispersal of a severe environmentally borne danger.

11. The method of claim 1 wherein the portable apparatus comprises a portable apparatus that is readily carriable by an average human.

12. The method of claim 11 wherein the portable apparatus comprises a pocketable form factor.

13. The method of claim 1 wherein the portable apparatus comprises at least one of:
a personally carriable apparatus;
a vehicle mountable apparatus;
a personally totable apparatus.

14. The method of claim 1 wherein the portable apparatus comprises a one-way wireless communications device.

15. The method of claim 14 wherein the portable apparatus comprises a one-way wireless communications device that is configured and arranged to only transmit the wireless location information.

16. The method of claim 1 wherein the portable apparatus comprises a two-way wireless communications device.

17. The method of claim 16 wherein the portable apparatus comprises a two-way wireless communications device that is configured and arranged to only permit outbound transmissions to an authorized representative of a rescue service provider.

18. The method of claim 1 wherein the portable apparatus comprises at least one of:
a cellular telephone;
a personal digital assistant;
an email platform;
a shortwave receiver;
a text messaging platform;
a two-way pager;
a satellite phone;
a stored audio playback platform;
a hand-held game;
a commercial broadcast receiver;
a key fob;
spectacles;
a wallet;
a pocket folio;
a belt;
a hair barrette;
a hair band;
jewelry;
a timepiece;
a writing instrument;
a binder.

19. The method of claim 1 wherein the portable apparatus comprises an environmental threat detector.

20. The method of claim 19 further comprising:
receiving wireless transmissions from the portable apparatus regarding environmental threat information.

21. The method of claim 19 wherein the enviromnental threat detector comprises a proximal radiation threat detector.

22. The method of claim 19 wherein the environmental threat detector comprises a proximal chemical agent threat detector.

23. The method of claim 19 wherein the environmental threat detector comprises a proximal biological agent threat detector.

24. The method of claim 1 wherein the portable apparatus comprises, at least in part, a global positioning satellite system receiver.

25. The method of claim 1 wherein the portable apparatus comprises, at least in part, a location beacon receiver.

26. The method of claim 1 further comprising:
conditioning, at least in part, operability of the portable apparatus as a function of an identifier as corresponds to a given one of the authorized beneficiaries.

27. The method of claim 26 wherein the identifier comprises authorized beneficiary-entered information.

28. The method of claim 27 wherein the authorized beneficiary-entered information comprises at least one of:
identifying information;
a password;
a personal identification number.

29. The method of claim 26 wherein the identifier comprises a biometric as corresponds to the given one of the authorized beneficiaries.

30. The method of claim 1 wherein receiving the wireless location information comprises:
receiving general location information when the portable apparatus operates in a first mode of operation; and
receiving specific location information that is more specific than the general location information when the portable apparatus operates in a second mode of operation that is different than the first mode of operation.

31. The method of claim 30 wherein the portable apparatus is configured and arranged to operate in the first mode of operation until the authorized beneficiary intentionally initiates the second mode of operation.

32. The method of claim 30 wherein the portable apparatus is configured and arranged to operate in the first mode of operation until reception of a wireless signal that initiates the second mode of operation.

33. The method of claim 1 wherein the portable apparatus is further configured and arranged to provide the corresponding authorized beneficiary with information regarding when a provider of the rescue services is unlikely to receive the wireless location information.

34. The method of claim 1 further comprising:
providing information regarding survival behaviors; and wherein the portable apparatus is configured and arranged to store and display the information regarding survival behaviors.

35. The method of claim 1 wherein using the wireless location information to facilitate maintaining a substantially immediate capability of rescuing the authorized beneficiaries in response to a civilly-catastrophic event further comprises:
adjusting substantially immediately available rescue resources as a function of the wireless location information.

36. The method of claim 35 wherein adjusting substantially immediately available rescue resources as a function of the wireless location information further comprises adjusting allocation of presently available substantially immediately available rescue resources as a function of the wireless location information.

37. The method of claim 35 wherein adjusting substantially immediately available rescue resources as a function of the wireless location information further comprises increasing a quantity of presently available substantially immediately available rescue resources as a function of the wireless location information.

38. The method of claim 35 wherein adjusting substantially immediately available rescue resources as a function of the wireless location information further comprises decreasing a quantity of presently available substantially immediately available rescue resources as a function of the wireless location information.

39. The method of claim 1 wherein accepting pre-catastrophe consideration-based private civil security subscriptions from subscribers with respect to providing civilly-catastrophic event-based rescue services for authorized beneficiaries comprises accepting pre-catastrophe consideration-based private civil security subscriptions from subscribers with respect to providing civilly-catastrophic event-based rescue services for authorized beneficiaries and at least one presently unnamed rescuee, wherein a given one of the authorized beneficiaries is able to identify the rescuee at a time of being rescued.

40. The method of claim 39 wherein the at least one presently unnamed rescuee comprises a living being.

41. The method of claim 39 wherein the at least one presently unnamed rescuee comprises an inanimate object.

42. The method of claim 1 wherein providing to the authorized beneficiaries a portable apparatus that transmits wireless location information regarding a location for a corresponding authorized beneficiary to a provider of the civilly-catastrophic event-based rescue services comprises providing a plurality of the portable apparatuses to a given one of the authorized beneficiaries.

43. The method of claim 1 wherein providing to the authorized beneficiaries a portable apparatus that transmits wireless location information regarding a location for a corresponding authorized beneficiary to a provider of the civilly-catastrophic event-based rescue services comprises:
providing a primary wireless transmitter to transmit the wireless location information to the provider;
providing a secondary wireless transmitter to transmit the wireless location information to the primary wireless transmitter.

44. The method of claim 1 wherein the portable apparatus is configured and arranged to determine an immediately local barometric pressure reading and wherein the wireless location information comprises, in part, the immediately local barometric pressure reading.

45. The method of claim 1 wherein the portable apparatus is configured and arranged to detect proximity of another of the portable apparatuses to thereby facilitate the authorized beneficiaries having the portable apparatuses locating one another prior to being rescued.

46. The method of claim 45 wherein the portable apparatus is further configured and arranged to provide a user-discernable indication of the proximity.

47. The method of claim 1 wherein the portable apparatus, is further configured and arranged to detect proximity of a beacon that comprises a guide to a facility that corresponds to a provider of the civilly-catastrophic event-based rescue services.

48. The method of claim 47 wherein the facility comprises at least one of:
a transportation rally point;
a rescue transport pickup point;
a short-term shelter;
a long-term shelter.
